(19) United States
(12) Patent Application Publication
(10) Pub. No.: US 2009/0070882 A1
(43) Pub. Date: Mar. 12, 2009

(54) METHOD FOR TRANSMITTING USER DATA BETWEEN SUBSCRIBERS AND SUBSCRIBER DEVICES THEREFOR

(76) Inventors: Frank Grass, Westoverledigen (DE); Keno Reiss, Aurich (DE); Heiko Thole, Heede (DE); Markus Willenborg, Friesoythe-Augustendorf (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/852,681

(22) Filed: Sep. 10, 2007

(51) Int. Cl. G06F 21/24; G06F 15/16

(52) U.S. Cl. 726/26; 709/204

(57) ABSTRACT

A method for transmitting user data (D) between subscribers in a network (N) by means of data messages (4) has the following steps:
allocating in each case one message counter (TC) to the data messages (4), the message counter (TC) being specified individually for each data message (4), and
ignoring the contents of user data (D) of a subscriber who receives a data message (4) containing the user data (D) if the message counter (TC) is not plausible on the basis of previously received data messages (4).

The invention relates to a method for transmitting user data between subscribers in a network by means of data messages, comprising:
allocating in each case one message counter to the data messages, the message counter being specified individually for each data message, and
ignoring the contents of user data from a subscriber who receives a data message containing the user data if the message counter of the data message is not plausible on the basis of previously received data messages.

The invention also relates to subscriber devices for transmitting and receiving user data in data messages by means of a network of subscriber devices comprising a data message generating unit for individually specifying a program counter for each data message to be sent out, allocating a specified message counter to the data message and sending out the data message containing user data to subscriber devices, and with a control device which is set up for checking the plausibility of the message counter of a received data message and ignoring the user data of the data message if the message counter is not plausible.

A transmission of user data by means of data messages in networks is carried out in the most varied manner and is applied, for example, in computer networks, mobile telephone networks, field bus applications, house control systems etc. One problem here is the checking of the validity of data messages which have been sent out by a transmitter and received by at least one subscriber.

From WO 2004/010400 A1, a method for transmitting commands between a transmitter and a receiver is known in which transmitted instructions are provided at least partially with a marker which is broadcast by the transmitter for performing an allocation to the commands associated with the instructions.

EP 0 809 379 A2 discloses an access control device in which a transmission key generated by means of a random number generator is transmitted encrypted in accordance with the challenge-response principle.

US 2006/0092943 A1 describes a network system for transporting GFP-encapsulated FICON frames via a SONET-SDH transport network. The data transmission frames are provided with a sequence number which is checked at the receiver in order to sort out duplicated or faulty data frames.

US 2003/0072455 A1 describes a method for detecting an attack on a network connection by checking whether a sequence number of a message lies within a valid sequence number range.

EP 1 361 704 A1 describes a method and a device for checking sequence numbers in the data communication in a UMTS network. Here, too, each message is sent out with an incremented sequence number so that the receiver, by incrementing the sequence number on reception of a data packet, can check whether the sequence number of the next received data packet corresponds to the incremented sequence number.

On the basis of this, it is the object of the present invention to improve a method for transmitting user data between subscribers in a network by means of data messages, in such a manner that, apart from securing and checking the validity of data messages by means of message counters, the security and transmission timing is improved.

The object is achieved by means of the method of the type initially mentioned in that the next transmission time of the transmitting subscriber for a subsequent data message is calculated as a function of the message counter of the preceding data message and of a subscriber address assigned to the transmitting subscriber.

By adding a message counter specified individually for each data message, the data messages are individually identified and can be checked for plausibility at the receiver. However, the data message is not only used for validity checking but also for determining the next transmission time, assigned to the transmitting subscriber, for the subsequent data message. Such utilization of the message counter is advantageous in particular if the message counter is incremented from one data message to the next data message.

The message counter is preferably simply incremented during the sending-out of successive data messages so that the value of the message counter is simply increased by one in each case by the transmitting subscriber from one data message to the next data message. The receiving subscriber can then simply determine whether the message counter of a data message of the transmitting subscriber has a correspondingly increased value in comparison with the message counter of the preceding data message sent off by the transmitting subscriber immediately before. If it is found in this manner that the message counter is not plausible, the user data of the data message are simply ignored. In this case, a return message to the transmitting subscriber and possibly a request for a new data message is also conceivable.

In an advantageous embodiment of the method, user data of data messages are ignored if the message counter of the data message matches a message counter of a data message received within a defined number or in accordance with a defined period before. Thus, message counters can be used several times by a transmitting subscriber by defining the number or the period, but not for data messages within the defined number or the defined period.

It is particularly advantageous if a random number, which is also transmitted in the associated data message, is used for securing the transmission of a data message. For this purpose, a random number is preferably generated by a subscriber expecting user data for reception, before the transmission of a data message, and is transmitted unencrypted to a transmitting subscriber from which the transmission of user data is expected. The transmitting subscriber then encrypts the random number and transmits the message counter together with the encrypted random number in an associated data message. The subscriber receiving the data message, which previously also has generated the random number and sent it out unencrypted checks the validity of the data message, the contents of user data being ignored if the message counter is not plausible due to previously received data messages and the random number does not correspond to the random number previously transmitted to the transmitting subscriber.

The comparison can be accelerated if the transmitted random number is also encrypted by the subscriber who has generated the random number and transmitted it unencrypted, and the validity of the random number transmitted back is checked by comparing the encrypted random numbers.

The random number can be, for example, a single binary bit added to the data message or can consist of a number of digital bits.

It is also the object of the present invention to create an improved subscriber device for transmitting and receiving data messages containing user data.

The object is achieved by means of the subscriber devices having the features of claims 11 to 20.

In the text which follows, the invention will be explained in greater detail by means of an illustrative embodiment, with reference to the attached drawings, in which:

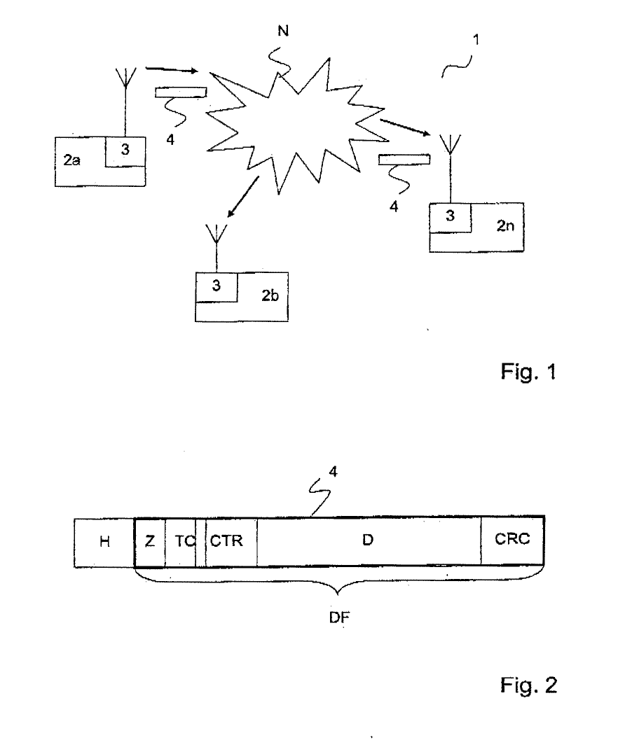

FIG. 1 shows a sketch of a network with subscriber devices for transmitting and receiving data messages;

FIG. 2 shows a sketch of an exemplary data message with message counter and random number.

FIG. 1 shows a sketch of a network 1 with a multiplicity of subscriber terminals 2a, 2b, . . . , 2n which in each case have a transmitting and/or receiving unit 3 for transmitting data messages 4 wirelessly by radio.

It lies within the capability of experts to use repeaters, if necessary, or to combine a wire-connected and wireless data transmission with one another.

The subscriber terminals 2 are preferably units which are utilized for controlling and monitoring installations in real estate such as, for example, heating controls, meteorological stations, door controls, louver controls, window openers/closers, ventilators, alarm installations etc.

At least one of the subscriber devices 2 can form a control center in this arrangement.

FIG. 2 shows a data message 4 which is provided for transmitting user data D between the subscriber terminals 2. The data message 4 has a data frame with a header H which contains, for example, a preamble and a synchronization word, and a data transmission frame DF with check data CRC at the end, the user data D, control data CTR and the message counter TC.

The data transmission frame DF can optionally additionally contain a random number Z which is specified individually with the aid of a random generator for from a subscriber expecting the reception of a data message 4.

The message counter TC is also individually specified for each data message 4. For this purpose, the transmitting subscriber devices 2 have a corresponding data message generating unit which is set up for generating and allocating the message counter TC. The message generating unit can be implemented, for example, as a program routine for a microprocessor or microcontroller.

The receiving subscriber devices 2 have a control unit for checking the plausibility of the message counters TC of the received data messages 4. In this arrangement, it is determined whether a data message 4 previously received already contained the same message counter TC. If this is the case, this suggests that the data message 4 sent out is faulty, for example because the data message 4 has been sent out by an unauthorized interferer with user data D, possibly altered, whilst retaining the remaining header information for obtaining access to the network N. The interferer has then received a corresponding data message 4 earlier with possibly altered user data D from a transmitting subscriber device 2 and now attempts to utilize this data message 4 for his own purposes.

For example a case is conceivable in which a house door lock can be opened with a radio key via the network N. An interferer could intercept the data messages 4 if the house door is opened by authorized users N with permitted radio keys. Following this, the interferer could send out the same data message 4 in order to open the door in an unauthorized manner. This can be done either by checking the identification of the transmitter by means of a return channel, known per se from the prior art. Predominantly, however, another approach is selected which does not require a return channel. This approach includes the message counter TC newly generated and sent out every time by the transmitting subscriber device 2 for each data message 4 and checking the validity of the data message 4 with the aid of the message counter TC.

The security can be improved even further by adding a random number Z to each data message 4. This further reduces the probability of data messages 4 with header information being intercepted and then utilized repeatedly in an unauthorized manner.

1. Method for transmitting user data (D) between subscribers in a network (N) by means of data messages (4) comprising:
allocating in each case one message counter (TC) to the data messages (4), the message counter (TC) being specified individually for each data message (4), and
ignoring the contents of user data CD) of a subscriber who receives a data message (4) containing the user data CD) if the message counter (TC) of the data message (4) is not plausible on the basis of previously received data messages (4),
characterized by
calculating the next transmitting time of the transmitting subscriber for a subsequent data message (4) as a function of the message counter (TC) of the preceding data message (4) and of a subscriber address assigned to the transmitting subscriber.

2. Method according to claim 1, characterized by incrementing the message counter (TC) during the allocation of message counters (TC) of successive data messages (4).

3. Method according to claim 1, characterized by ignoring user data (ID) of data messages (4) if the message counter (TC) of the data message (4) matches a message counter (TC) of one of data messages (4) received within a defined number previously.

4. Method according to claim 2, characterized by ignoring user data (ID) of data messages (4) if the message counter (TC) does not match the incremented message counter (TC) of the data message (4) received immediately before.

5. Method according to claim 1, characterized by
generating a random number (Z) by a subscriber who expects the reception of user data (D), before the transmission of a data message (4),
unencrypted transmitting of the random number (z) to a transmitting subscriber from which the sending-out of user data (D) is expected,
encrypting the random number (Z) by the transmitting subscriber,
transmitting the message counter (TC) together with the encrypted random number (Z) in the associated data message (4), and
checking the validity of the data message (4) with the message counter (TC) and the random number (z) by the subscriber receiving the data message (4), wherein the contents of user data CD) are ignored by the subscriber who receives the data message (4) containing the user data (D) if the message counter (TC) is not plausible on the basis of previously received data messages (4) and. the random number (Z) does not match the random number (Z) previously transmitted to the transmitting subscriber.

6. Method according to claim 1, characterized by
generating a random number (Z) by a subscriber who has received user data CD) in a data message (4),
unencrypted sending of the random number (z) to the transmitting subscriber who has sent out the data message (4),
encrypting of the random number (2) by the transmitting subscriber,
transmitting the encrypted random number (2) to the subscriber who has received the user data (ID), and
checking of the validity of the user data (ID) by the subscriber receiving the user data (ID), wherein the contents of user data (ID) are ignored by the subscriber who receives the data message (4) containing the user data (ID) if the message counter (TC) is not plausible on the basis of previously received data messages (4) and the random number (2) does not match the random number (Z) transmitted to the transmitting subscriber.

7. Method according to claim 5, characterized by encrypting of the transmitted random number (2) by the subscriber transmitting the random number (z) unencrypted, and checking of the validity of the random number (2) transmitted back by comparing the encrypted random numbers (Z).

8. Method according to claim 5 claim 5, characterized by decrypting of the random number (2) transmitted back encrypted, by the subscriber transmitting the random number (z) unencrypted, and checking of the validity of the random number (Z) transmitted back by comparing the decrypted random numbers (Z).

9. Method according to claim 5, characterized in that the random number (Z) is a binary bit.

10. Subscriber device for transmitting user data (ID) in data messages (4) in a network (N) of subscriber devices (2) by means of a data message generating unit which is set up for individually specifying a message counter (TC) for each data message (4) to be sent out, allocating the specified message counter (TC) to the data message (4) and sending out the data message (4) containing the user data (ID) to subscriber devices (2), and with a control device which is set up for checking the plausibility of the message counter (TC) of a received data message (4) and ignoring the user data (ID) of the data message (4) if the message counter (TC) is not plausible, characterized in that the subscriber device (2) is set up for calculating the next transmitting time of the transmitting subscriber device (2) for a subsequent data message (4) as a function of the message counter (TC) of the preceding data message (4) and a subscriber address assigned to the transmitting subscriber device (2)

11. Subscriber device according to claim 10, characterized in that the data message generating unit is set up for incrementing the message counter (TC) of data messages (4) to be sent out successively.

12. Subscriber device according to claim 10, characterized in that the data message generating unit is set up for encrypting a random number (Z) received unencrypted, and sending out the encrypted random number (2) together with the message counter (TC) in the associated data message (4).

13. Subscriber device according to claim 10, characterized in that the control unit is set up for ignoring the user data (n) of data messages (4) if the message counter (TC) of the data message (4) matches a message counter (TC) of a data message (4) received within a defined number previously.

14. Subscriber device according to claim 10, characterized in that the control unit is set up for ignoring the user data (D) of data messages (4) if the message counter (TC) does not match the incremented message counter (TC) of the data message (4) received immediately before.

15. Subscriber device according to claim 10, characterized in that the subscriber device (2) is set up for generating a random number (Z), unencrypted sending out of the random number (2) to a transmitting subscriber from which the sending-out of user data CD) is expected, and checking of the validity of a data message (4) containing the message counter (TC) and the encrypted random number (Z), wherein the contents of user data (ID) are ignored if the message counter (TC) is not plausible on the basis of previously received data messages (4) and the random number (2) does not match the random number (Z) previously transmitted to the transmitting subscriber.

16. Subscriber device according to claim 15, characterized in that the subscriber device (2) is set up for encrypting the random number (2) sent out unencrypted to a subscriber, and comparing the encrypted random number (2) with the random number (2) received encrypted.

17. Subscriber device according to claim 10, characterized in that the subscriber device (2) has a radio transmitting and/or radio receiving unit (3) for wirelessly transmitting the data messages (4).
